(19) United States
(12) Patent Application Publication
(10) Pub. No.: US 2023/0274230 A1
(43) Pub. Date: Aug. 31, 2023

(54) PLAN VALIDATION AND POLICY CHECKS FOR INFORMATION TECHNOLOGY ENVIRONMENTS

(71) Applicant: Scalr, Inc., San Francisco, CA (US)

(72) Inventors: Igor Savchenko, Walnut Creek, CA (US); Sebastian Stadil, Seattle, WA (US)

(21) Appl. No.: 18/113,107

(22) Filed: Feb. 23, 2023

Related U.S. Application Data
(60) Provisional application No. 63/259,913, filed on Feb. 25, 2022.

(51) Int. Cl. G06Q 10/10

(52) U.S. Cl. CPC G06Q 10/103

(57) ABSTRACT

Embodiments are directed to methods and systems for information technology (IT) resource management in workspaces maintaining configurations of API-manageable resources. In various embodiments the method includes queuing a run including a plan of proposed changes to a configuration maintained by a first workspace, and determining one or more policies associated with the first workspace. In various embodiments, the method includes determining a policy check of the first plan indicating that the proposed changes to the configuration would violate a policy in the one or more policies and indicating an enforcement parameter for the violated policy. In various embodiments, the method includes, prior to an apply of the first plan, notifying a user of the policy check by indicating the violated policy and the enforcement level parameter of the violated policy.

### RELATED APPLICATIONS

The present application claims the benefit of U.S. Provisional Patent Application No. 63/259,913, filed Feb. 25, 2022, the disclosure of which is incorporated by reference herein in its entirety.

### TECHNICAL FIELD

The present disclosure relates to information technology resource management and, more specifically, to management of one or more workspaces configured for maintaining configurations of API-manageable resources within a computing infrastructure.

### BACKGROUND

Information technology (IT) infrastructure refers generally to the resources and services required for the establishment and operation of an IT environment. IT environments in turn, are then used by an enterprise or other organization to provide IT services to its employees and customers. Resources include hardware, software, and network resources, and can be provided remotely. For example, resources can be provided as Software-as-a-Service (SaaS), Platform-as-a-Service (PaaS), Infrastructure-as-a-Service (IaaS), web application, and the like.

Hardware resources are used to host software resources and include servers, computers, storage, routers, switches, and the like. Software resources include applications that are used by the enterprise or other organization for internal purposes or customer-facing purposes. For example, software resources can include enterprise resource planning (ERP) software applications, customer relationship management (CRM) software applications, productivity software applications, and the like. Network resources include the resources used to provide network connectivity, security, and the like. Remote access to software and hardware resources may be enabled and regulated by the network resources.

Within the IT environment, users can establish one or more workspaces to be available as a configuration of resources within the IT infrastructure. The one or more workspaces each include a configuration file that describes the rules for use of IT infrastructure, and values serving as inputs for the configuration file. The one or more workspaces also reference a state file describing the state of the IT infrastructure. Users can assign various projects to the one or more workspaces where there may be many people working on the same project, such as using a cloud-computing application, or where users work independently on different portions of the project

Improvements to the field of IT infrastructure systems for the establishment and operation of IT environments would be welcome

### SUMMARY

Embodiments of the present disclosure are directed to methods, systems, and computer program product for information technology (IT) resource management in one or more workspaces configured for maintaining configurations of API-manageable resources within a computing infrastructure.

According to various embodiments, a method of IT resource management includes queuing a run on a first workspace of the one or more workspaces, the queued run including a first plan of proposed changes to a configuration of API-manageable resources maintained by the first workspace within the computing infrastructure. In one or more embodiments the method includes determining one or more policies associated with the first workspace. In various embodiments the one or more policies each include operating parameters for the first workspace and an enforcement level parameter. In one or more embodiments the method further includes determining a policy check of the first plan. In various embodiments the policy check indicates that the proposed changes to the configuration maintained by the first workspace would violate a policy in the one or more policies and indicating the enforcement parameter for the violated policy. In one or more embodiments, the method includes, prior to an apply of the first plan, notifying a user of the policy check by indicating the violated policy and the enforcement level parameter of the violated policy.

According to certain embodiments, a method of IT resource management includes receiving a proposed change to a first policy group associated with the one or more workspaces. In various embodiments the first policy group includes one or more policies each comprising operating parameters for the one or more workspaces. In various embodiments the method further includes determining a policy check of the proposed change. In one or more embodiments the policy check includes determining one or more workspaces associated with the first policy group that maintain a configuration of API-manageable resources that violate the proposed change to the first policy group, and prior to enacting the proposed change to the first policy group, notifying a user of the policy check. In one or more embodiments the user is notified by indicating the one or more workspaces that maintain a configuration of API-manageable resources that violate the proposed change to the first policy group.

According to various embodiments, an IT resource management system includes an IT infrastructure including cloud resources comprising one or more of hardware resources, software resources, and network resources. In one or more embodiments the system further includes an IT infrastructure controller networked with the IT infrastructure. In various embodiments the controller includes a processor and a computer readable non-transitory memory including computer executable instructions. In various embodiments the instructions are executable by the processor to cause the processor to establish one or more cloud workspaces configured for maintaining a configuration of cloud resources and queue a run on a first cloud workspace of the one or more cloud workspaces. In various embodiments, the run includes a plan for applying a configuration of cloud resources to the IT infrastructure. In one or more embodiments, the instructions are executable by the processor to cause the processor to determine a first policy group associated with the first cloud workspace, the first policy group including one or more policies each comprising operating parameters for the first workspace, each of the one or more policies including an enforcement level parameter indicating an enforcement priority of a policy relative to one or more other policies.

In one or more embodiments, the instructions are executable by the processor to cause the processor to, prior to applying the plan, determine a policy check of the planned run, the policy check indicating that the plan, when applied, would violate a policy in the first policy group associated with the first cloud workspace and indicating the enforcement parameter for the violated policy. In various embodiments, the instructions are executable by the processor to cause the processor to, prior to applying the plan, notify an owner of the first policy group of the policy check by indicating the violated policy and the enforcement level parameter of the violated policy.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system diagram of an information technology (IT) system, according to one or more embodiments of the disclosure.

FIG. 2 depicts a block diagram of an IT system including IT environments and one or more workspaces, according to one or more embodiments of the disclosure.

FIG. 3A depicts a block diagram of a run being executed by an IT infrastructure controller, according to one or more embodiments of the disclosure.

FIG. 3B depicts a block diagram of a run being executed by an IT infrastructure controller, according to one or more embodiments of the disclosure.

FIG. 4 depicts a method of resource management in one or more workspaces maintaining configurations of API-manageable resources within a computing infrastructure, according to one or more embodiments of the disclosure.

FIG. 5 depicts an example user-interface for a policy check notification to a user, according to one or more embodiments of the disclosure.

FIG. 6 depicts a block diagram of a policy run being executed by an IT infrastructure controller, according to one or more embodiments of the disclosure.

FIG. 7 depicts a method of IT resource management in one or more workspaces maintaining a configuration of API-manageable resources within a computing infrastructure, according to one or more embodiments of the disclosure.

FIG. 8 depicts a logical device including a processor and a computer readable storage unit are depicted, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

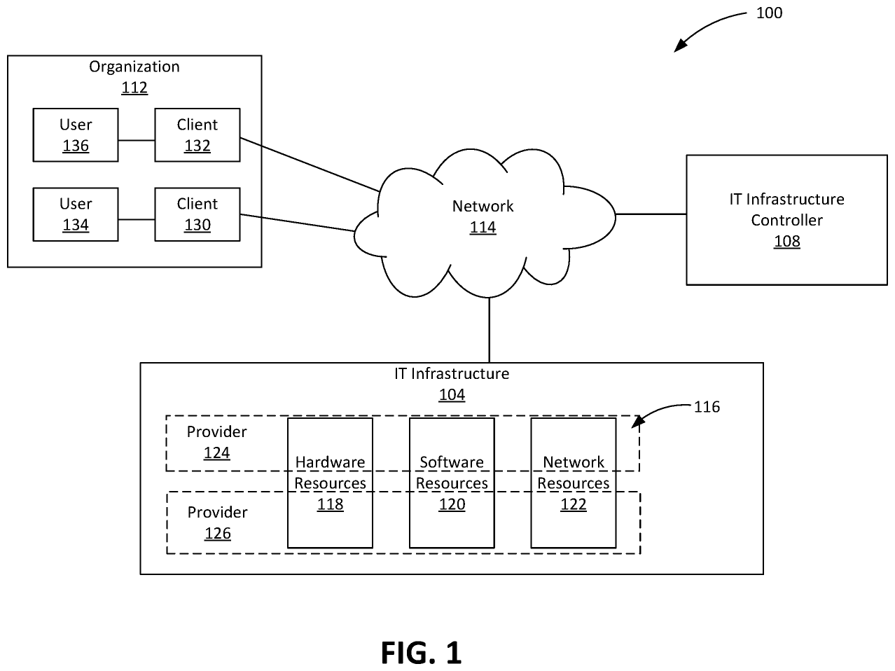

Referring to FIG. 1, an information technology (IT) system 100 is depicted. In various embodiments, the system 100 includes an IT infrastructure 104, an IT infrastructure controller 108, and an organization 112. In one or more embodiments, the IT infrastructure 104, IT infrastructure controller 108, and the organization 112 are communicatively coupled via a network 114 which includes any wired or wireless network including, for example, a local area network (LAN), a wide area network (WAN), a public land mobile network (PLMN), the Internet, and the like.

In various embodiments the IT infrastructure 104 includes a collection of one or more resources 116 including hardware resources 118, software resources 120, and network resources 122. In various embodiments, resources 116 are sourced from or otherwise provided by one or more providers 124, 126. In such embodiments, providers 124, 126 are entities that own or otherwise control access to the resources 116 in the IT infrastructure 104. In some embodiments, providers 124, 126 are private providers such that at least a portion of the resources 116 are owned by the organization 112. In some embodiments, the providers 124, 126 are third party providers that provide access to resources as an infrastructure-as-a-service (IaaS) provider, a platform-as-a-service (PaaS) provider, a software-as-a-service (SaaS) provider, or the like. In such embodiments at least a portion of the resources 116 can be shared amongst multiple organizations. In certain embodiments, the provider(s) 124, 126 can include the organization 112, such as where the organization owns or otherwise controls access to the resources themselves.

In various embodiments, resources 116 are defined or organized into one or more “blocks” that are managed by the system 100 for provisioning or de-provisioning components of the infrastructure 104. For example, depicted in FIG. 1, the infrastructure 104 is organized into a plurality of resource blocks that include a hardware resource 118, a software resource 120, and a network resource 122. In one or more embodiments the blocks can include various information such as arguments, parameters, variables, tags, strings and the like which can be used to configure the resource. For example, the block could include strings indicating the resource type, the resource name, and the provider 124, 126. Further, while the resource blocks depicted in FIG. 1 as being defined by the type of resource (e.g., hardware, software, network), in certain embodiments the blocks could be organized according to a different manner. For example, the block could be organized based on the provider and/or could include including multiple types of resources in a single block.

In one or more embodiments, the IT infrastructure controller 108 is a logical device configured for programmatic control of access to resources 116 via a resource management API or other kind of software. In such embodiments, the controller 108 can create, check, modify, or delete the access to resources 116 for the organization 112 or other entity in the system 100.

For example, in various embodiments the controller 108 is configured to control access to the resources 116 to host various software applications for the organization 112 and/or to ensure that the performance of the hosted software satisfies a threshold performance metric, such as a service level objective (SLO). Thus, in various embodiments the controller 108 is configured to provision, modify, and/or de-provision the one or more resources 116 as part of configuring the IT infrastructure 104.

For example, in one or more embodiments, based on the IaC instructions the controller 108 generates a plan that describes what the controller 108 will do to reach the desired state of infrastructure indicated by the configuration. The controller 108 can then execute or “apply” the plan to build the described infrastructure. Although in certain embodiments, the execution or application of the generated plan is optional and the controller 108 may simply generate the plan without an apply.

In various embodiments, the IaC instructions can be included within a configuration file. In such embodiments, the configuration file can represent a potential configuration of infrastructure that can be put into effect by the controller 108. For example, in one or more embodiments the configuration file includes resource definitions, environment variables, input variables, and/or other information described using an IaC language. A configuration file can be obtained by a user of a client computer and provided to the controller 108 to provision or de-provision infrastructure resources to match the state of infrastructure described by IaC instructions in the file. In various embodiments, configuration files describe the components needed to run an application, process, or the like. For example, in one or more embodiments the configuration file can be used by the user to provision resources in order to support the deployment, testing, and/or maintenance of a software application, and/or to ensure that the performance of the hosted software satisfies a threshold performance metric, such as a service level objective. In various embodiments, the configuration file can be obtained by a user from a database or registry of existing configuration files or can created by the user or by the organization 112.

In some embodiments, the IT controller 108 can configure the infrastructure 104 using infrastructure as code (IaC) where the infrastructure 104 may be configured via software. For example, in such embodiments the controller 108 can apply one or more configuration files to the IT infrastructure 104 that specify a desired state of the infrastructure 104 as well as one or more corresponding variables. For example, to support the deployment, testing, and/or maintenance of a software application, the IT infrastructure 104 may be configured based on a configuration file created, for example, by the organization 112 to provision, modify, and/or de-provision the one or more resources 116 to host the software application.

In one or more embodiments, the organization 112 is a unit for and grouping clients, users, and the like, together and for controlling the group's access to resources 116 in the IT infrastructure 104. In various embodiments, the organization 112 can represent an enterprise or a sub-group within the enterprise, such as a business unit within the company. As shown in FIG. 1, the organization 112 can include one or more clients 130, 132, along with one or more associated users 134, 136 that interact with the system 100. Further, it should be appreciated that while FIG. 1 depicts a single organization 112, additional organizations, clients, and users may be included in the system 100.

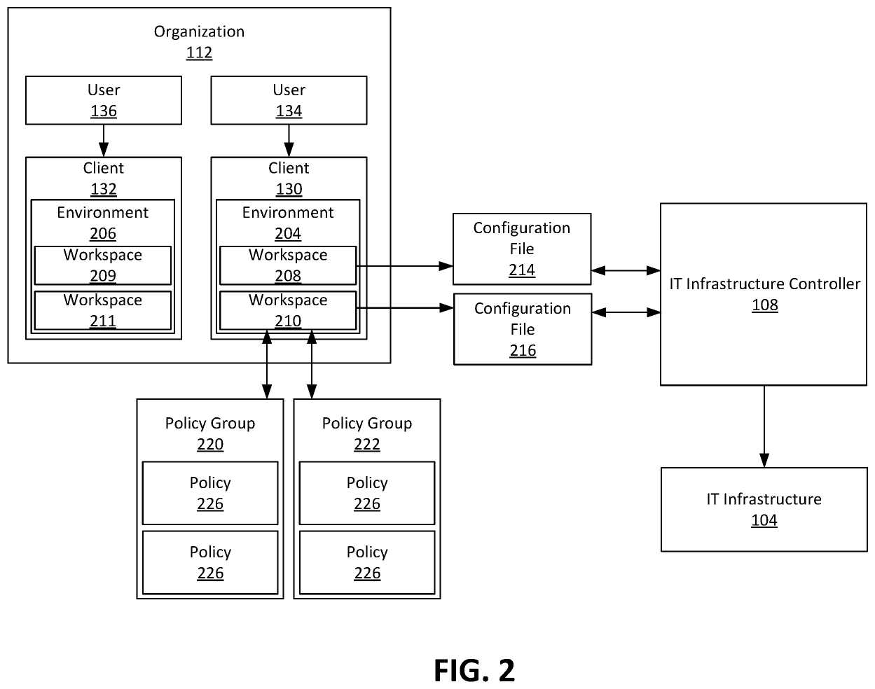

Referring to FIG. 2, a block diagram of the organization 112 and IT environments 204, 206 is depicted, according to one or more embodiments. In various embodiments, the environment 200 includes an organization 112 grouping together one or more clients 130, 132 each associated with one or more users 134, 136. In various embodiments the clients 130, 132 each includes an IT environment 204 which includes one or more workspaces 208.

In one or more embodiments, a workspace is a unit for grouping a configuration of resources that is planned to be provisioned or has been provisioned by the controller 108. In such embodiments, the planned or provisioned configuration of resources occurs within a workspace, and each workspace contains everything necessary to manage a given collection of infrastructure. For instance, in various embodiments the workspace contains configuration information including a configuration file and one or more state files. As described above, a configuration file is a file including IaC instructions representing a potential configuration of infrastructure that can be put into effect by the controller 108. For example, in one or more embodiments the configuration file includes resource definitions, environment variables, input variables, and/or other information described using an IaC language. A configuration file can be obtained by a user of a client computer and provided to the controller 108 to provision or de-provision infrastructure resources to match the state of infrastructure described by IaC instructions in the file. In various embodiments the configuration file can be obtained, inputted, or initialized from a configuration database of existing configuration files or can created as a new file by the user or by the organization 112.

In various embodiments, state files serve as a “source of truth” for the workspace by including information that indicates a current state of infrastructure 104 including the resources corresponding to each workspace. For example, in various embodiments the system stores the IDs and properties of the resources it manages for the workspace in the state file, so that it can update or destroy those resources going forward. As such, the state file functions as a reference point for making changes to infrastructure 104 to match a configuration described in the configuration file.

In or more embodiments, this configuration information is maintained by the system and then is used whenever it executes an operation in the context of that workspace. For example, to further modify the infrastructure to provision or deprovision resources in that workspace. As such, in various embodiments the workspace will produce specific runs, including plans and/or applies, that are specific to each workspace. In one or more embodiments, each workspace retains backups or a database of configuration information. For example, in various embodiments the workspace includes a state file database including some or all previous state files associated with the workspace. For example, the state file database can be useful for tracking changes to the workspace over time or recovering from problems. In certain embodiments, the workspace includes a run history database that includes a record of all run activity, including one or more of summaries, logs, a reference to the changes that caused the run, and user comments.

In one or more embodiments each workspace 208-211 is associated with a configuration file. For example, a first workspace 208 is associated with a first configuration 214 and a second workspace 210 is associated with a second configuration 216. For clarity, configuration files associated with workspaces 209, 211 are omitted from FIG. 2. As described above, the configuration 214, 216 is a file that specifies a desired state of the infrastructure 104 as well as one or more corresponding variables at a specific moment in time.

In one or more embodiments, each workspace is associated with a policy group. For example, the workspace 210 is associated with a first policy group 220 and a second policy group 222. In various embodiments, each policy group is a combination of one or more policies 226 each comprising code or operating parameters for the associated workspaces. In various embodiments, each policy 226 additionally includes an enforcement level parameter. Described further below, in one or more embodiments the enforcement parameter indicates how the system treats a respective policy in the event of a violation. For example, the enforcement parameter for a policy could indicate that a policies may be violated under certain conditions whereas another enforcement parameter for the policy could indicate that the policy cannot be violated, or stipulate other outcomes in the event of policy violation.

In one or more embodiments the IT infrastructure controller 108 is configured to perform one or more operations to provision, modify, and/or de-provision resources at the infrastructure 104 to apply the configurations 214, 216 associated with the workspaces. As such, in various embodiments the creation or modification of the configuration files 214, 216 to the infrastructure 104 is the process by which infrastructure 104 is modified. In various embodiments, this process is referred to as a “Run”. Performing a run to make modifications to the configuration files 214, 216 is expected such as when new configurations need to be added to the environment or existing configurations need to be modified. In various embodiments the IT infrastructure controller 108 is configured to generate or plan the runs, thereby modifying or creating proposed changes to the configuration which, in some embodiments, are then applied by the controller 108 and to the infrastructure 104.

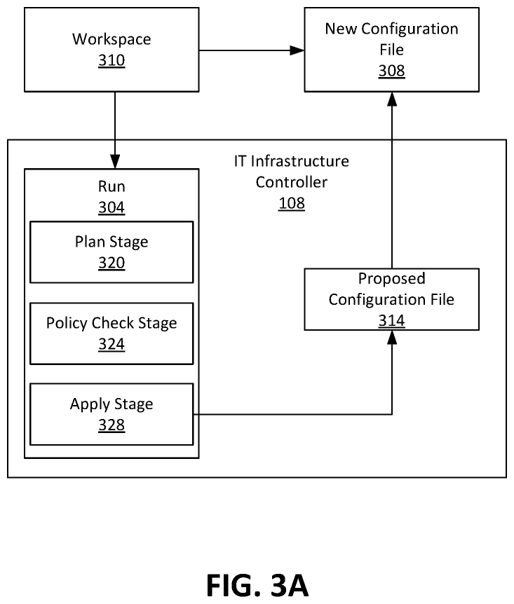

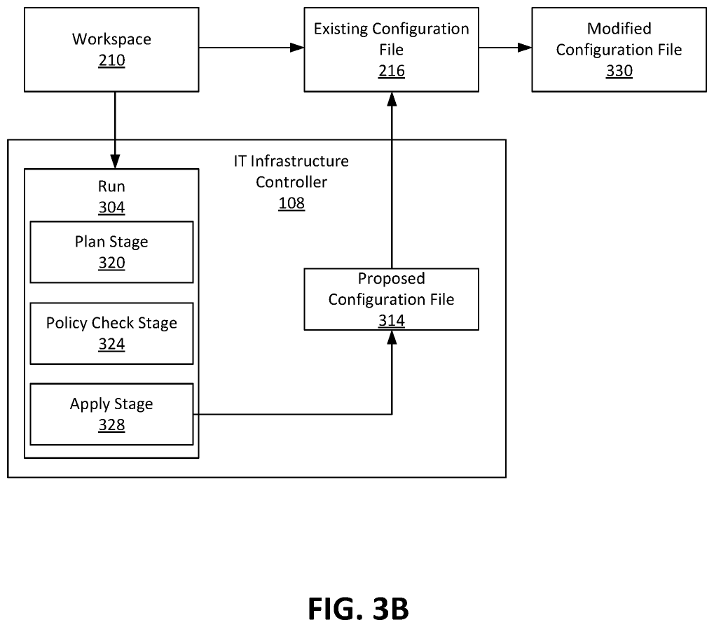

For example, referring additionally to FIGS. 3A-3B, a block diagram of a run 304 being executed by the IT infrastructure controller 108 is depicted. Referring specifically to FIG. 3A, the IT infrastructure controller 108 is depicted adding a new configuration 308 with the addition of a new workspace 310 to modify the infrastructure 104 and match an updated state specified by a proposed configuration 314. Referring specifically to FIG. 3B, the IT infrastructure controller 108 is depicted modifying an existing configuration to modify the infrastructure 104 and match an updated state specified by the proposed configuration 314.

In various embodiments, the run 304 comprises a number of actions or stages including a plan stage 320, a policy check stage 324 and an apply stage 328. However, in certain embodiments the run 304 could include fewer stages or more stages. For example, in some embodiments, the run 304 could include only a plan stage 320 and a policy check stage 324 and not include the apply stage 328. In one or more embodiments the plan stage 320 includes comparing the infrastructure state to a proposed configuration and proposed variables, determines which changes are necessary to make the state match the proposed configuration. In one or more embodiments, a plan file is a file including declarative language describing proposed changes to the configuration. In one or more embodiments, the apply stage 328 includes carrying out the changes declared by the plan and applying the changed configuration to the infrastructure 104. In various embodiments, this includes provisioning and/or de-provisioning resources accessible by the workspace 210. In some embodiments, the apply stage 328 can be automatically executed subsequent to the plan stage 320. However, in other embodiments, the apply stage 328 can wait for approval or feedback to perform the apply. In some embodiments, the apply stage 328 is conditional on passing/validation of the plan obtained in the policy check stage 324.

In one or more embodiments, the policy check 324 is a validation process for resource management that functions as a check on the plan stage 320 and proposed configurations 314 prior to their approval. For instance, in various embodiments the policy check validates or rejects the plan created at the plan stage 320 prior to applying the plan. In such embodiments, the policy check 324 compares the proposed configuration to one or more existing policies associated with the workspace 210. For example, the policy check 324 determines whether the proposed configuration file 314 would result in provisioning and/or de-provisioning of resources resulting in a modified configuration file 330 or a new configuration file 3008 which violates a policy associated with the workspace 210, 310. In one or more embodiments, the policy check 324 validates or rejects the plan based on whether the proposed configuration file 314 results in a policy violation. For example, rejecting a plan where the proposed configuration file 314 results in a policy violation and validating the plan where the proposed configuration file 314 does not result in a policy violation. In one or more embodiments, validation of the plan is further based on the enforcement parameter for a violated policy.

For example, in one or more embodiments the policy check 324 will validate the plan where the enforcement level parameter of the violated policy indicates that the policy is low priority or optional. In some embodiments, where the enforcement level parameter allows, the policy check 324 will validate the plan based on receiving approval from a user for the resulting policy violation. In certain embodiments the policy check will reject the plan based on the enforcement level parameter of the violated policy indicated by automatically rejecting the plan where the enforcement parameter indicates that the violated policy is critical or otherwise not optional. In various embodiments where the plan is rejected this can prevent the run from proceeding to the apply stage 328.

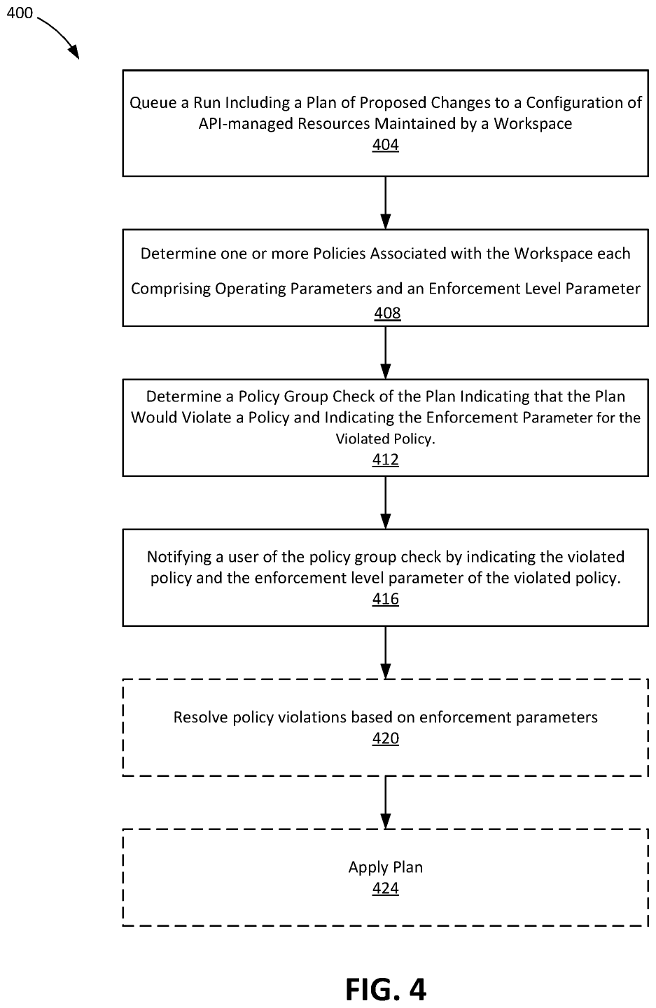

In light of FIGS. 3A-3B, and referring to FIG. 4, a method 400 of resource management in one or more workspaces maintaining configurations of API-manageable resources within a computing infrastructure is depicted. In one or more embodiments the method 400 includes, at operation 404, queuing a run on a first workspace, the run including a first plan of proposed changes to a configuration of API-manageable resources maintained by the first workspace within the computing infrastructure.

In one or more embodiments, the method 400 includes, at operation 408, determining one or more policies associated with the first workspace, the one or more policies each comprising operating parameters for the first workspace and an enforcement level parameter.

In one or more embodiments, the method 400 includes, at operation 412, determining a policy check of the first plan, the policy check indicating that the proposed changes to the configuration maintained by the first workspace would violate a policy in the first policy group and indicating the enforcement parameter for the violated policy.

In one or more embodiments, the method 400 includes, at operation 416, prior to an apply of the first plan, notifying a user of the policy check by indicating the violated policy and the enforcement level parameter of the violated policy.

In one or more embodiments, the method 400 optionally includes, at operation 420 resolving policy violations based on enforcement parameters. As described above, in various embodiments, the policy check can validate the plan where the enforcement level parameter of the violated policy indicates that the policy is low priority or optional. In some embodiments, where the enforcement level parameter allows, the policy check will validate the plan based on receiving approval from a user for the resulting policy violation. In such embodiments, the policy violations can be considered “resolved” in that the violations have been noted by a user and approved for implementation of the proposed plan. As such, in one or more embodiments, the method 400 optionally includes, at operation 424, applying the plan.

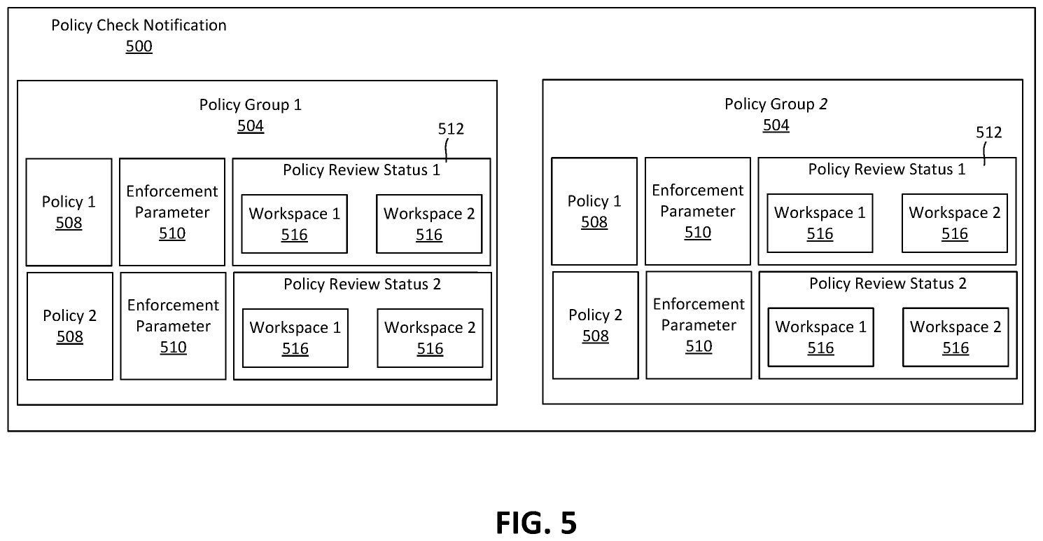

Referring to FIG. 5 an example of a policy check notification 500 for a user is depicted, according to one or more embodiments. In various embodiments, the policy check notification 500 is an example user-interface or display for notifying a user of the result of a policy check. For example, in various embodiments policy check notification 500 is presented to a user in operation 416 of method 400, discussed above. Similarly, policy check notification 500 in certain embodiments is presented to a user in operation 712 of method 700, discussed further below. In one or more embodiments, the policy check notification 500 includes one or more one or more policy groups 504. In one or more embodiments, each of the policy groups 504 includes a display of the one or more policies 508 within the respective policy group 504. Further, for each of the policies 504, the notification 500 indicates an enforcement parameter 510 for the respective policy 508. In one or more embodiments a policy review status 512 is displayed with each policy. In one or more embodiments, the policy review status 512 indicates the status of the corresponding policy 508 with regard to each workspace 516 associated with the policy group 504. As such, in various embodiments the policy review status 512 presents information to a user quickly regarding each workspace 516 and whether the proposed policy triggering the policy check notification 500 would cause violations for each policy 508 and identifying which workspaces 516 would have violations.

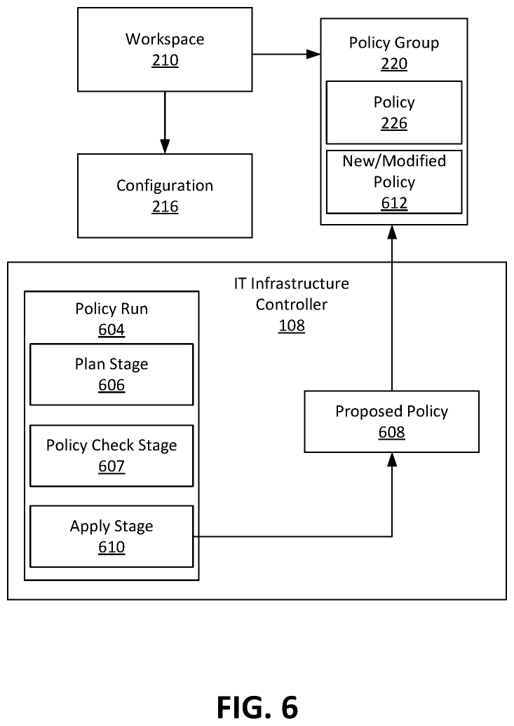

As discussed above, FIGS. 3A-4 depict various embodiments where a policy check is executed in response to a run, where a plan or a proposed change to a configuration file is proposed and evaluated. However, in various embodiments policy checks can be executed in response to a proposed change to a policy or policy group associated with a workspace. For example, in one or more embodiments, the IT infrastructure controller 108 can execute a process referred to herein as a “policy run” where a new policy or modification to an existing policy is generated. For example, referring to FIG. 6, a block diagram of a policy run 604 executed by the IT infrastructure controller 108 is depicted. In various embodiments, the IT infrastructure controller 108 is depicted generating a proposed policy 608 for inclusion into a first policy group 220 as a new or modified policy 612. In various embodiments, the first policy group 220 is associated with the workspace 210 and includes one or more existing policies 226 including one or more rules for operation for the workspace 210. As such, the first policy group defines the operating parameters for the workspace 210 and changes to the first policy group 220 can thereby change the operating parameters for the workspace 210. As a result, if the new/modified policy 612 is implemented it is possible that the workspace 210 and its configuration 216 will violate the operating parameters in the new/modified policy 612.

In various embodiments, the policy run 604 comprises a number of actions or stages including a plan stage 606, a policy check stage 607 and an apply stage 610. However, in certain embodiments the policy run 604 could include fewer stages or more stages. For example, in some embodiments, the policy run 604 could include only a plan stage 606 and a policy check stage 607 and not include the apply stage 610. In one or more embodiments the plan stage 606 includes determining the proposed policy 608 as a set of operating parameters that govern an associated workspace. In certain embodiments, such as when the proposed policy is a modification to an existing policy, the IT infrastructure controller 108 compares the existing policy to a proposed policy 608 and determines which changes are necessary to make the existing policy match the proposed policy 608.

In one or more embodiments, the apply stage 610 includes carrying out the changes declared by the proposed policy and applying the changed policy to the policy group 220. In some embodiments, the apply stage 610 can be automatically executed subsequent to the plan stage 606. However, in other embodiments, the apply stage 610 can wait for approval or feedback to perform the apply. In some embodiments, the apply stage 610 is conditional on passing/validation of the proposed policy obtained in the policy check stage 610.

In one or more embodiments, the policy check 607 is a validation process that functions as a check on the plan stage 606 and proposed policy 608 prior to its approval. For instance, in various embodiments the policy check validates or rejects the proposed policy 608 created at the plan stage 606 prior to applying the proposed policy. For example, the policy check 607 determines whether the proposed policy 608 would result in a policy violation in the first policy group associated with the workspace 210. In one or more embodiments, the policy check 607 validates or rejects the proposed policy 608 based on whether the proposed policy 608, when included in the policy group, would result in a policy violation. For example, rejecting a proposed policy where it would be violated by the current configuration of the workspace 210 and validating the proposed policy where the proposed policy does not result in a policy violation. In one or more embodiments, validation of the policy is further based on the enforcement parameter for the proposed policy 608. For example, in one or more embodiments the policy check 607 will validate the proposed policy 608 where the enforcement level parameter of the policy indicates that the policy is low priority or optional. In some embodiments, where the enforcement level parameter allows, the policy check 607 will validate the proposed policy based on receiving approval from a user for the resulting policy violation. In certain embodiments the policy check will reject the proposed policy based on the enforcement level parameter of the violated policy indicated by automatically rejecting the proposed policy 608 where the enforcement parameter indicates that the violated policy is critical or otherwise not optional. In various embodiments where the proposed policy 608 is rejected this can prevent the policy run 604 from proceeding to the apply stage 610.

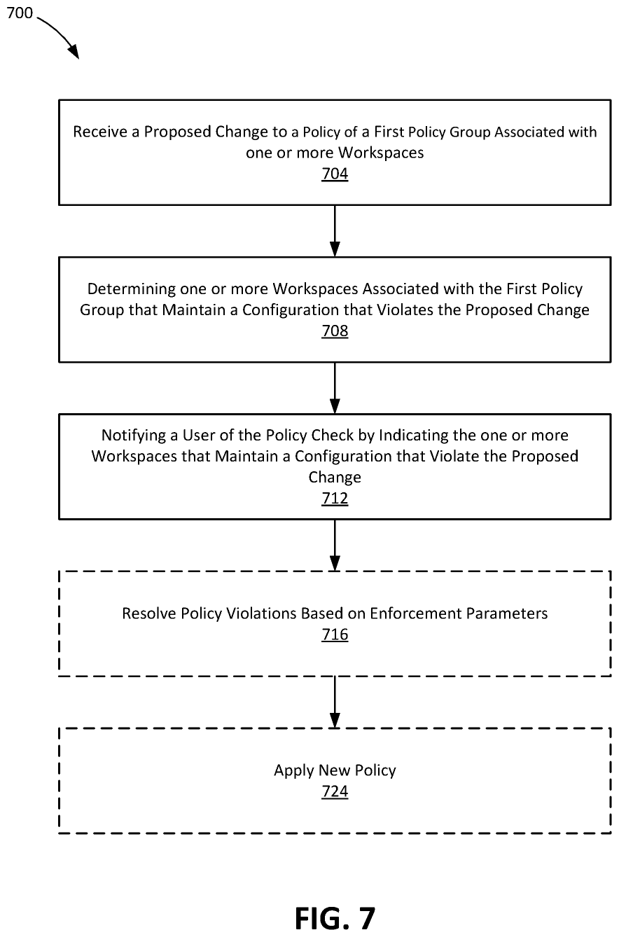

Referring to FIG. 7 a method 700 of IT resource management in one or more workspaces maintaining a configuration of API-manageable resources within a computing infrastructure is depicted. In one or more embodiments. In one or more embodiments the method 700 includes, at operation 702, receiving a proposed change to a policy of a first policy group associated with one or more workspaces. In various embodiments the first policy group including one or more policies each comprising operating parameters for the one or more workspaces. In one or more embodiments, the proposed change can include a modification to a policy existing in the policy group. In certain embodiments the proposed change can include the addition of a new policy into the first policy group.

In one or more embodiments, the method 700 further includes, at operations 708-712, determining a policy check of the proposed change. In various embodiments, the policy check includes, at operation 708, determining one or more workspaces associated with the first policy group that maintain a configuration of resources that violate the proposed change. In one or more embodiments, the policy check includes, at operation 712, prior to enacting the proposed change to the first policy group, notifying a user of the policy check by indicating the one or more workspaces that maintain a configuration that violates the proposed change to the first policy group. In one or more embodiments notification can occur via, a policy check notification, such as the notification 500 depicted in FIG. 5 and described above.

In one or more embodiments, the method 700 optionally includes, at operation 716 resolving policy violations based on enforcement parameters. As described above, in various embodiments, the policy check can validate the proposed change where the enforcement level parameter of the violated policy indicates that the policy is low priority or optional. In some embodiments, where the enforcement level parameter allows, the policy check will validate the proposed change based on receiving approval from a user for the resulting policy violation. In such embodiments, the policy violations can be considered “resolved” in that the violations have been noted by a user and approved for implementation. As such, in one or more embodiments, the method 700 optionally includes, at operation 724, applying the proposed change to the first policy group.

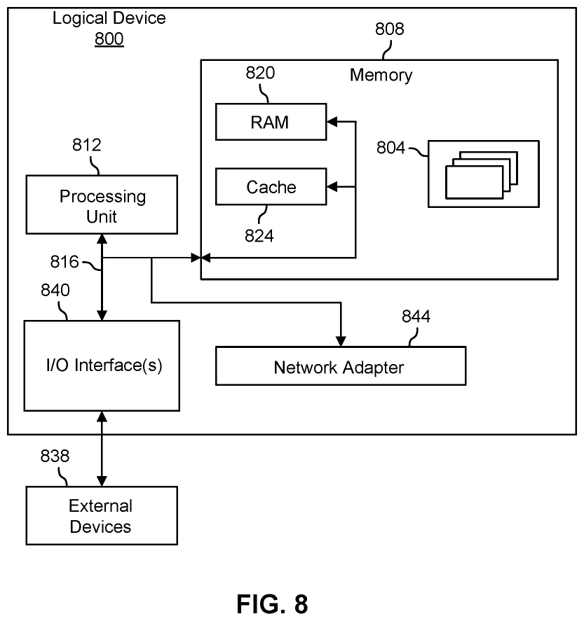

Referring to FIG. 8, a logical device 800 including a processor and a computer readable storage unit are depicted, according to one or more embodiments of the disclosure. In various embodiments, logical 800 is for use in IT management system for executing various embodiments of the disclosure as described above. For example, and as described herein, logical device 800 can be configured to execute and/or store various program instructions as a part of a computer program product. Logical device 800 may be operational with general purpose or special purpose computing system environments or configurations, such as the systems described according the embodiments herein.

Examples of computing systems, environments, and/or configurations that may be suitable for use with logical device 800 include, but are not limited to, personal computer systems, server computer systems, handheld or laptop devices, multiprocessor systems, mainframe computer systems, distributed computing environments, and the like.

Logical device 800 may be described in the general context of a computer system, including executable instructions, such as program modules 804, stored in system memory 808 being executed by a processor 812. Program modules 804 may include routines, programs, objects, instructions, logic, data structures, and so on, that perform particular tasks or implement particular abstract data types. Program modules 804 may be practiced in distributed computing environments where tasks are performed by remote processing devices that are linked through a network. In a distributed computing environment, program modules 804 may be located in both local and remote computer system storage media including memory storage devices. As such, in various embodiments logical device 800 can be configured to execute various program modules 804 or instructions for executing various embodiments of the disclosure. For example, in various embodiments logical device 800 can be configured to execute a run or a policy run to generate proposed changes to a configuration or to modify polices in a policy group associated with a workspace.

The components of the logical device 800 may include, but are not limited to, one or more processors 812, memory 808, and a bus 816 that couples various system components, such as, for example, the memory 808 to the processor 812. Bus 816 represents one or more of any of several types of bus structures, including, but not limited to, a memory bus and/or memory controller, a peripheral bus, and a local bus using a suitable of bus architecture.

In one or more embodiments, logical device 800 includes a variety of computer readable media. In one or more embodiments, computer readable media includes both volatile and non-volatile media, removable media, and non-removable media.

Memory 808 may include computer readable media in the form of volatile memory, such as random access memory (RAM) 820 and/or cache memory 824. Logical device 800 may further include other volatile/non-volatile computer storage media such as hard disk drive, flash memory, optical drives, or other suitable volatile/non-volatile computer storage media. As described herein, memory 808 may include at least one program product having a set (e.g., at least one) of program modules 804 or instructions that are configured to carry out the functions of embodiments of the disclosure.

Logical device 800 may also communicate with one or more external devices 838 such as other computing nodes, a display, keyboard, or other I/O devices, via an I/O interface(s) 840 for transmitting and receiving sensor data, instructions, or other information to and from the logical device 800. In one or more embodiments, I/O interface 840 includes a transceiver or network adaptor 844 for wireless communication. As such, in one or more embodiments, I/O interface 840 can communicate or form networks via wireless communication.

One or more embodiments may be a computer program product. The computer program product may include a computer readable storage medium (or media) including computer readable program instructions for causing a processor to enhance target intercept according to one or more embodiments described herein. The computer readable storage medium is a tangible device that can retain and store instructions for use by an instruction execution device. The computer readable storage medium may be, for example, an electronic storage device, a magnetic storage device, an optical storage device, or other suitable storage media.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Program instructions, as described herein, can be downloaded to respective computing/processing devices from a computer readable storage medium or to an external computer or external storage device via a network, for example, the Internet, a local area network, a wide area network and/or a wireless network. A network adapter card or network interface in each computing/processing device may receive computer readable program instructions from the network and forward the computer readable program instructions for storage in a computer readable storage medium within the respective computing/processing device.

Computer readable program instructions for carrying out one or more embodiments, as described herein, may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a single computer, or partly on the single computer and partly on a remote computer. In some embodiments, the computer readable program instructions may execute entirely on the remote computer. In the latter scenario, the remote computer may be connected to the single computer through any type of network, including a local area network (LAN) or a wide area network (WAN), or public network.

One or more embodiments are described herein with reference to flowchart illustrations and/or block diagrams of methods, systems, and computer program products according to one or more of the embodiments described herein. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the method steps discussed above, or flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The method steps, flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some embodiments, the functions noted in the block may occur out of the order noted in the figures. For example, two blocks shown in succession may in fact, be executed substantially concurrently, or the blocks may sometimes be executed in the reverse order, depending upon the functionality involved.

In one or more embodiments, the program instructions of the computer program product are configured as an “App” or application executable on a laptop or handheld computer utilizing a general-purpose operating system. As such, in various embodiments can be implemented on a handheld device such as a tablet, smart phone, or other device.

In various embodiments, the code/algorithms for implementing one or more embodiments are elements of a computer program product, as described above, as program instructions embodied in a computer readable storage medium. As such, such code/algorithms can be referred to a program instruction means for implementing various embodiments described herein.

In addition, to the above disclosure, U.S. Pat. No. 11,223,526 is hereby incorporated by reference.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method of information technology (IT) resource management in one or more workspaces configured for maintaining configurations of API-manageable resources within a computing infrastructure, the method comprising:
queuing a run on a first workspace of the one or more workspaces, the queued run including a first plan of proposed changes to a configuration of API-manageable resources maintained by the first workspace within the computing infrastructure;
determining one or more policies associated with the first workspace, the one or more policies each comprising operating parameters for the first workspace and an enforcement level parameter;
determining a policy check of the first plan, the policy check indicating that the proposed changes to the configuration maintained by the first workspace would violate a policy in the one or more policies and indicating the enforcement parameter for the violated policy;
prior to an apply of the first plan, notifying a user of the policy check by indicating the violated policy and the enforcement level parameter of the violated policy.

2. The method of IT resource management of claim 1, further comprising:
based on the enforcement level parameter of the violated policy indicated by the policy check, validating the first plan without receiving input from the notified user.

3. The method of IT resource management of claim 1, further comprising:
based on the enforcement level parameter of the violated policy indicated by the policy check, requesting approval to validate the first plan.

4. The method of IT resource management of claim 1, further comprising:
based on the enforcement level parameter of the violated policy indicated by the policy check, rejecting the first plan.

5. The method of IT resource management of claim 1, further comprising:
determining a second plan of proposed changes to the configuration of API-manageable resources maintained by the first workspace;
prior to an apply of the second plan, determining a second policy check of the second plan, the policy check indicating that the proposed changes to the configuration maintained by the first workspace would not violate a policy in the one or more policies; and
prior to an apply of the second plan, notifying the user of the second policy check.

6. The method of IT resource management of claim 1, wherein the one or more policies are included in a first policy group associated with the first workspace.

7. The method of IT resource management of claim 6, further comprising:
determining one or more additional policy groups associated with the first workspace, the one or more additional policy groups each including one or more policies comprising operating parameters for the first workspace and enforcement level parameters;
wherein the policy check further indicates that the proposed changes to the configuration maintained by the first workspace would violate a policy in the one or more additional policy groups associated with the first workspace and further indicates the enforcement parameter for the violated policy; and
notifying the user of the policy check by indicating the violated policy in the one or more additional policy groups and the enforcement level parameter of the violated policy.

8. The method of IT resource management of claim 1, wherein the API-manageable resources are one or more of hardware resources, software resources, and network resources.

9. The method of IT resource management of claim 1, wherein the computing infrastructure is a cloud computing infrastructure.

10. A method of information technology (IT) resource management in one or more workspaces configured for maintaining configurations of API-manageable resources within a computing infrastructure, the method comprising:
receiving a proposed change to a first policy group associated with the one or more workspaces, the first policy group including one or more policies each comprising operating parameters for the one or more workspaces;
determining a policy check of the proposed change, the policy check comprising:
determining one or more workspaces associated with the first policy group that maintain a configuration of API-manageable resources that violate the proposed change to the first policy group; and
prior to enacting the proposed change to the first policy group, notifying a user of the policy check by indicating the one or more workspaces that maintain a configuration of API-manageable resources that violate the proposed change to the first policy group.

11. The method of IT resource management of claim 10, wherein the policy check further comprises:
determining a conflict between the proposed change and one or more other policies in the first policy group, wherein the conflict indicates that the one or more other policies would be violated by a configuration of API-manageable resources in compliance with the proposed change; and
wherein notifying the user of the policy check further includes indicating the conflict.

12. The method of IT resource management of claim 10, wherein the one or more workspaces are further associated with a second policy group including one or more policies each comprising operating parameters for the one or more workspaces, and wherein:
determining the policy check of the proposed change further comprises:
determining a conflict between the proposed change and one or more other policies in the second policy group, wherein the conflict indicates that the one or more other policies would be violated by a configuration of API-manageable resources in compliance with the proposed change; and
the method further comprises:
prior to enacting the proposed change, notifying the user of the policy check by indicating the conflict between the proposed change and the one or more other policies in the second policy group.

13. The method of IT resource management of claim 10, further comprising:
enacting the proposed policy without receiving instructions from the owner of the first policy group based on the enforcement level parameter of the proposed policy and based on the enforcement level parameters of the one or more other policies in the first policy group where compliance with the proposed policy would cause a policy violation.

14. The method of IT resource management of claim 10, further comprising:
requesting approval from the policy group holder to enact the proposed policy based on the enforcement level parameter of the proposed policy and based on the enforcement level parameters of the one or more other policies in the first policy group where compliance with the proposed policy would cause a policy violation.

15. An information technology (IT) resource management system comprising:
an IT infrastructure comprising cloud resources including one or more of hardware resources, software resources, and network resources;
an IT infrastructure controller networked with the IT infrastructure, the controller comprising:
a processor; and
computer readable non-transitory memory including computer executable instructions, the instructions executable by the processor to cause the processor to:
establish one or more cloud workspaces configured for maintaining a configuration of cloud resources;
queue a run on a first cloud workspace of the one or more cloud workspaces, the run including a plan for applying a configuration of cloud resources to the IT infrastructure;
determine a first policy group associated with the first cloud workspace, the first policy group including one or more policies each comprising operating parameters for the first workspace, each of the one or more policies including an enforcement level parameter indicating an enforcement priority of a policy relative to one or more other policies;
prior to applying the plan, determine a policy check of the planned run, the policy check indicating that the plan, when applied, would violate a policy in the first policy group associated with the first cloud workspace and indicating the enforcement parameter for the violated policy;
prior to applying the plan, notify an owner of the first policy group of the policy check by indicating the violated policy and the enforcement level parameter of the violated policy.

16. The system of claim 15, wherein the instructions executable by the processor further cause the processor to:
based on the enforcement level parameter of the violated policy indicated by the policy check, validate the first plan without receiving input from the notified user.

17. The system of claim 15, wherein the instructions executable by the processor further cause the processor to:
based on the enforcement level parameter of the violated policy indicated by the policy check, request approval to validate the first plan.

18. The system of claim 15, wherein the instructions executable by the processor further cause the processor to:
based on the enforcement level parameter of the violated policy indicated by the policy check, reject the first plan.

19. The system of claim 15, wherein the instructions executable by the processor further cause the processor to:
determine a second plan of proposed changes to the configuration of API-manageable resources maintained by the first workspace;
prior to an apply of the second plan, determine a second policy check of the second plan, the policy check indicating that the proposed changes to the configuration maintained by the first workspace would not violate a policy in the first policy group; and
prior to an apply of the second plan, notify the user of the second policy check.

20. The system of claim 15, wherein the instructions executable by the processor further cause the processor to:
determine one or more additional policy groups associated with the first workspace, the one or more additional policy groups each including one or more policies comprising operating parameters for the first workspace and enforcement level parameters;
wherein the policy check further indicates that the proposed changes to the configuration maintained by the first workspace would violate a policy in the one or more additional policy groups associated with the first workspace and further indicates the enforcement parameter for the violated policy; and
notify the user of the policy check by indicating the violated policy in the one or more additional policy groups and the enforcement level parameter of the violated policy.
